(19) United States
(12) Patent Application Publication
(10) Pub. No.: US 2023/0113301 A1
(43) Pub. Date: Apr. 13, 2023

(54) MANAGING QUERIES TO NON-RELATIONAL DATABASES WITH MULTIPLE PATHS TO STORAGE SYSTEM

(71) Applicant: International Business Machines Corporation, Armonk, NY (US)

(72) Inventors: Gandhi Sivakumar, Bentleigh (AU); Luke Peter Macura, Lucas (AU); Kushal S. Patel, Pune (IN); Sarvesh S. Patel, Pune (IN)

(21) Appl. No.: 17/500,143

(22) Filed: Oct. 13, 2021

(51) Int. Cl. G06F 16/245; G06F 16/2453; G06F 11/34

(52) U.S. Cl. CPC G06F 16/24569; G06F 16/24542; G06F 11/3409

(57) ABSTRACT

A computer-implemented method, system and computer program product for managing queries to non-relational databases. A query to retrieve an object from a storage system of a non-relational database system is received from an application. A disk volume of the storage system is then identified from a record of the requested object. Upon identifying the disk volume, the logical and/or physical input/output connections to the identified disk volume that are tagged to dissimilar CPU cores of the storage system are identified. One of the identified logical and/or physical input/output connections is then selected based on the input/output access characteristics of the identified logical and/or physical input/output connections, the CPU core speeds for the CPU cores and a determined level of urgency for the retrieval of the object. The request is then sent to the storage system over the selected input/output connection.

### TECHNICAL FIELD

The present disclosure relates generally to non-relational databases, such as NoSQL databases, and more particularly to managing queries to non-relational databases (e.g., NoSQL databases) with multipath storage connections (i.e., multiple paths to the storage system).

### BACKGROUND

Non-relational databases are databases that are not “relational.” Relational databases present the data to the user as relations (a presentation in tabular form, i.e., as a collection of tables with each table consisting of a set of rows and columns). However, non-relational databases provide a mechanism for storage and retrieval of data that is modeled in means other than the tabular relations used in relational databases. An example of such a non-relational database is the NoSQL (“non-structured query language (SQL)”) database.

### SUMMARY

In one embodiment of the present disclosure, a computer-implemented method for managing queries to non-relational databases comprises receiving a query to retrieve an object from a storage system of a non-relational database system. The method further comprises receiving a query to retrieve an object from a storage system of a non-relational database system. The method additionally comprises identifying a disk volume of the storage system from a record of the object. Furthermore, the method comprises identifying logical and/or physical input/output connections to the disk volume of the storage system, where each of the logical and/or physical input/output connections corresponds to a path from the non-relational database to the disk volume of the storage system, and where each of the logical and/or physical input/output connections comprises one or more input/output queues tagged to a dissimilar central processing unit (CPU) core of the storage system. Additionally, the method comprises obtaining CPU core speeds for CPU cores of the storage system. In addition, the method comprises selecting one of the identified logical and/or physical input/output connections to be used to send a request to the storage system to retrieve the object based on input/output access characteristics of the identified logical and/or physical input/output connections, the CPU core speeds for the CPU cores and a determined level of urgency for retrieval of the object. The method further comprises sending the request to the storage system over the selected logical or physical input/output connection.

Other forms of the embodiment of the computer-implemented method described above are in a system and in a computer program product.

The foregoing has outlined rather generally the features and technical advantages of one or more embodiments of the present disclosure in order that the detailed description of the present disclosure that follows may be better understood. Additional features and advantages of the present disclosure will be described hereinafter which may form the subject of the claims of the present disclosure.

### BRIEF DESCRIPTION OF THE DRAWINGS

A better understanding of the present disclosure can be obtained when the following detailed description is considered in conjunction with the following drawings, in which:

FIG. 1 illustrates a communication system for practicing the principles of the present disclosure in accordance with an embodiment of the present disclosure;

FIG. 2 illustrates the multiple input/output connections between a disk volume of the storage system and the non-relational database system in accordance with an embodiment of the present disclosure;

FIG. 3 is a diagram of the software components of the non-relational database system used to select one of the input/output connections between the non-relational database system and the storage system to send the request issued by the non-relational database system to the storage system with the appropriate level of urgency in accordance with an embodiment of the present disclosure;

FIG. 4 illustrates an embodiment of the present disclosure of the hardware configuration of the non-relational database system which is representative of a hardware environment for practicing the present disclosure;

FIG. 5 is a flowchart of a method for building a pattern of input/output access characteristics over each path between the non-relational database system and its storage system in accordance with an embodiment of the present disclosure; and

FIG. 6 is a flowchart of a method for managing queries to a non-relational database system by utilizing the multiple input/output connections to the storage system in which the query urgency is propagated to the storage system along one of these input/output connections in accordance with an embodiment of the present disclosure.

### DETAILED DESCRIPTION

As stated in the Background section, non-relational databases are databases that are not “relational.” Relational databases present the data to the user as relations (a presentation in tabular form, i.e., as a collection of tables with each table consisting of a set of rows and columns). However, non-relational databases provide a mechanism for storage and retrieval of data that is modeled in means other than the tabular relations used in relational databases. An example of such a non-relational database is the NoSQL (“non-structured query language (SQL)”) database.

NoSQL databases (e.g., MongoDB®) are increasingly being used in big data and real-time web applications. NoSQL systems are also sometimes called “Not only SQL” to emphasize that they may support SQL-like query languages or sit alongside SQL databases in polyglot-persistent architectures.

Motivations for this approach include simplicity of design, simpler “horizontal” scaling to clusters of machines (which is a problem for relational databases), finer control over availability and limiting the object-relational impedance mismatch. The data structures used by NoSQL databases (e.g., key-value pair, wide column, graph, or document) are different from those used by default in relational databases, making some operations faster in NoSQL. The particular suitability of a given NoSQL database depends on the problem it must solve. Sometimes the data structures used by NoSQL databases are also viewed as “more flexible” than relational database tables.

Instead of the typical tabular structure of a relational database, NoSQL databases house data within one data structure, such as a JavaScript Object Notation (JSON), Extensible Markup Language (XML) or Binary JSON (BSON) document. Since this non-relational database design does not require a schema, it offers rapid scalability to manage large and typically unstructured data sets.

A NoSQL database is also a type of a distributed database, which means that information is copied and stored on various servers, such as in a storage system, which can be remote or local. This ensures availability and reliability of data. If some of the data goes offline, the rest of the database can continue to run.

Such a storage system may include a set of disk volumes. A “disk volume,” as used herein, refers to a portion of the storage system. Such a set of disk volumes may correspond to raw disk volumes, which store data in raw, binary form.

The storage system may be accessible to the NoSQL database via a cloud computing environment, such as a hybrid cloud computing environment. A hybrid cloud computing environment is a composition of a public cloud and a private environment, such as a private cloud or on-premise resources, that remain distinct entities but are bound together, offering the benefits of multiple deployment models.

In the hybrid cloud implementation, the applications may be running on the physical hybrid cloud servers (or virtual machines on top of the server layer), which may issue requests to read data from the storage system connected to the NoSQL database. The storage disks of the storage system may be connected to the NoSQL database via the means of an interconnected storage area network (SAN) fabric. In such a case, the SAN fabric may include different paths from the NoSQL database and the disk volume of the storage system. That is, there may be different paths to reach the same virtual disk in the storage system from the NoSQL database, where each path to each disk volume may operate with different characteristics of speed, processing power, etc.

A transmission protocol, such as NVMe® (non-volatile memory express), may be utilized for accessing non-volatile storage media, such as the non-volatile storage media in the storage system connected to the NoSQL database. Using such technology may result in many input/output connections being created over a single physical connection to gain the benefits of parallelizing input/output connections. As a result, a NoSQL disk volume may have multiple paths (“multipath”), each path having one or more input/output queues which are tagged to a dissimilar CPU core in the storage system. In such a scenario, there could be clock speed differences between the CPU cores which can affect the input/output performance when requested on certain paths.

Unfortunately, NVMe based standards have no multipath policy. As a result, the NoSQL database cannot obtain information about the multiple input/output connections created for the same disk volumes. Furthermore, if an application, such as AI application, issues a query desiring to retrieve an object (e.g., JSON object) urgently (requiring immediate retrieval) from the storage system, there is not currently a means for propagating such a query urgency (e.g., retrieval urgency) to the storage system, such as over one of these input/output connections, due to the operational differences between the NoSQL database and the storage system.

Hence, there is not currently a means for NoSQL databases to utilize the multiple input/output connections created in a multi-connection input/output transmission protocol (e.g., NVMe) as well as propagate a query urgency to the storage system, such as via one of these input/output connections.

The embodiments of the present disclosure provide a means for a non-relational database (e.g., NoSQL database) to utilize the multiple input/output connections created in a multi-connection input/output transmission protocol (e.g., NVMe) in which the query urgency is propagated to the storage system along one of these input/output connections.

In some embodiments of the present disclosure, the present disclosure comprises a computer-implemented method, system and computer program product for managing queries to non-relational databases. In one embodiment of the present disclosure, a query to retrieve an object from a storage system of a non-relational database system (e.g., NoSQL database system) is received from an application, such as an AI application, where the storage system is connected to the non-relational database system via a hybrid cloud environment. In one embodiment, the storage system is an object based storage system, in which data is stored in the form of “objects” in the storage system on flat address space based on its content and other attributes. A disk volume of the storage system is then identified from a record of the requested object, such as an identifier (e.g., label) that is associated with such a disk volume. Upon identifying the disk volume, the logical and/or physical input/output connections to the identified disk volume that are tagged to dissimilar CPU cores are identified, such as via a data structure storing a listing of the logical and/or physical input/output connections connected to various disk volumes of the storage system. In one embodiment, each of the logical and/or physical input/output connections include one or more input/output queues tagged to a dissimilar central processing unit (CPU) core of the storage system. After the CPU core speeds (e.g., clock speeds) for the CPU cores of the storage system are obtained, one of the identified logical and/or physical input/output connections connected to the identified disk volume is selected based on the input/output access characteristics of the identified logical and/or physical input/output connections, the CPU core speeds for the CPU cores and a determined level of urgency for the retrieval of the object. In one embodiment, such input/output access characteristics (e.g., input/output latency, bandwidth, response time, packet drops, congestion, etc.) and CPU core speeds for the CPU cores are obtained from data structures (e.g., tables). In one embodiment, the level of urgency for the retrieval of the object is determined based on the object category of the object requested to be retrieved and/or the type of application requesting to retrieve the object. Based on the determined level of urgency (e.g., critical) for the retrieval of the object, the required input/output access characteristics for the input/output connection as well as the required CPU core speed to be utilized in sending the request to the storage system to retrieve the object is determined, such as via a data structure listing such requirements associated with various levels of urgency. After identifying one of the input/output connections from the identified input/output connections that is tagged to a CPU core that both meet or most closely meets such requirements, the non-relational database system sends the request (e.g., read request) to the storage system over the selected input/output connection in a hybrid cloud environment. In this manner, the non-relational database system is able to utilize multiple input/output connections established by a multi-connection input/output transmission protocol (e.g., NVMe) in which the urgency of the query is propagated to the storage system along one of these input/output connections.

In the following description, numerous specific details are set forth to provide a thorough understanding of the present disclosure. However, it will be apparent to those skilled in the art that the present disclosure may be practiced without such specific details. In other instances, well-known circuits have been shown in block diagram form in order not to obscure the present disclosure in unnecessary detail. For the most part, details considering timing considerations and the like have been omitted inasmuch as such details are not necessary to obtain a complete understanding of the present disclosure and are within the skills of persons of ordinary skill in the relevant art.

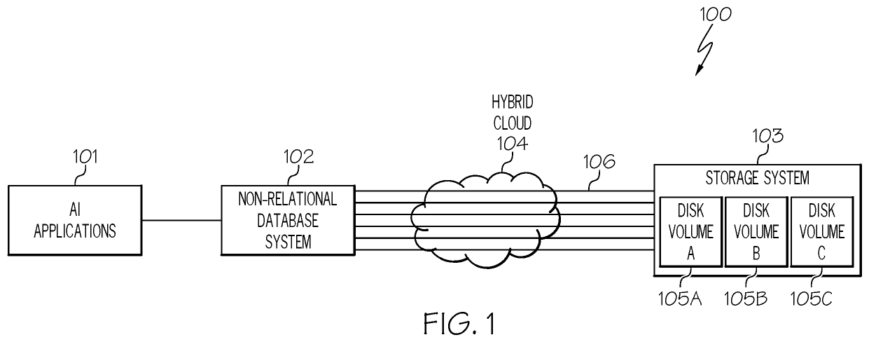

Referring now to the Figures in detail, FIG. 1 illustrates an embodiment of the present disclosure of a communication system 100 for practicing the principles of the present disclosure. Communication system 100 includes applications, such as artificial intelligence (AI) applications 101, sending queries to a non-relational database system 102, such as a NoSQL database system, to retrieve an object from a storage system 103 of non-relational database system 102.

In one embodiment, AI applications 101 are connected to non-relational database system 102 via a hybrid cloud environment (not shown in FIG. 1). In such an embodiment, AI applications 101 are running on the physical hybrid cloud servers. In one embodiment, AI applications 101 are running on the virtual machines on the top of the server layer. “Artificial intelligence (AI),” as used herein, refers to intelligence exhibited by machines. “AI applications,” as used herein, refer to applications of AI, which involve applications of AI in various aspects, such as e-commerce, navigation, robotics, human resource, healthcare, agriculture, gaming, automobiles, social media, marketing, etc. In one embodiment, AI applications 101 store metadata and their supervised data in storage system 103 of non-relational database system 102. While the following discusses the present disclosure in connection with utilizing AI applications, it is noted that other types of applications may be utilized by the present disclosure to send queries to retrieve an object from a storage system of a non-relational database.

Non-relational database system 102 provides a mechanism for the storage and retrieval of data, such as from storage system 103, that is modeled in means other than the tabular relations used in relational databases. An example of such a non-relational database is the NoSQL (“non-structured query language (SQL)”) database.

In one embodiment, non-relational database system 102 houses data within one data structure, such as a JSON, XML or BSON document. Such a non-relational database system may be referred to herein as a “non-relational document database” that stores “documents.” In one embodiment, such documents encapsulate and encode data (or information) in a standard format or encoding. Encodings include XML, YAML, and JSON and binary forms, such as BSON. Documents are addressed in the database via a unique key that represents that document.

In one embodiment, non-relational database system 102 is connected to its storage system 103 via a hybrid cloud environment 104. Hybrid cloud environment 104, as used herein, refers to a composition of a public cloud and a private environment, such as a private cloud or on-premise resources, that remain distinct entities but are bound together.

In one embodiment, storage system 103 is an object based storage system, in which data is stored in the form of “objects” in storage system 103 on flat address space based on its content and other attributes rather than the file name and the location. In one embodiment, each object stored in storage system 103 is identified by a unique identifier called an “object ID.” The object ID allows easy access to objects without the need to specify the storage location.

In one embodiment, storage system 103 includes a set of disk volumes 105A-105C (identified as “Disk Volume A,” “Disk Volume B,” and “Disk Volume C,” respectively). Disk volumes may collectively or individually be referred to as disk volumes 105 or disk volume 105, respectively.

A “disk volume 105,” as used herein, refers to a portion of storage system 103. Such a set of disk volumes 105 may correspond to raw disk volumes, which store data in raw, binary form. Such data may include metadata and supervised data that was saved by AI systems.

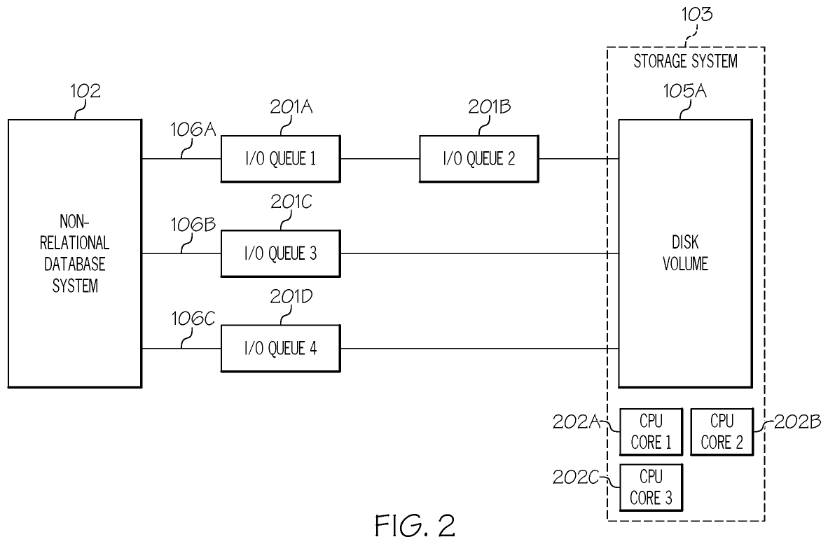

In one embodiment, storage disks 105 of storage system 103 are connected to non-relational database system 102 via multiple paths 106 through hybrid cloud environment 104. Paths 106 may collectively or individually be referred to as paths 106 or path 106, respectively. In one embodiment, there are different paths 106 to reach the same virtual disk 105 in storage system 103 from non-relational database system 102 as discussed below in connection with FIG. 2, where each path 106 to each disk volume 105 may operate with different characteristics of speed, processing power, etc. In one embodiment, such paths 106 may be logical and/or physical input/output connections. The notation (“/”) in the phrase “input/output” connections, as used herein, refers to “or.” Hence, the phrase “input/output connections,” as used herein, refer to input connections or output connections.

In one embodiment, a multi-connection input/output transmission protocol, such as NVMe® (non-volatile memory express), is utilized for accessing virtual disks 105 of storage system 103 by non-relational database system 102. In such a protocol, there are multiple input/output connections created over a single physical connection to gain the benefit of parallelizing input/output connections. Such input/output connections are represented by paths 106 of FIG. 1. It is noted that the phrase “input/output connections” and “paths” are used interchangeably herein and have the same meaning.

In one embodiment, each path 106 may have one or more input/output queues which are tagged to a dissimilar central processing unit (CPU) core in storage system 103 as shown in FIG. 2

Referring to FIG. 2, FIG. 2 illustrates the multiple input/output connections between a disk volume 105 of storage system 103 and non-relational database system 102 in accordance with an embodiment of the present disclosure.

As illustrated in FIG. 2, in connection with FIG. 1, paths 106A-106C, representing input/output connections of paths 106 of FIG. 1, are connected between non-relational database system 102 and disk volume 105A of storage system 103. As discussed above, each of these paths 106 (paths 106A-106C) include one or more input/output queues which are tagged to different CPU cores in storage system 103. For example, path 106A includes input/output queue 201A (identified as “I/O Queue 1” in FIG. 2) and input/output queue 201B (identified as “I/O Queue 2” in FIG. 2) tagged to CPU core 202A (identified as “CPU Core 1” in FIG. 2) of storage system 103. By tagging such a path 106A to CPU core 202A, the request being transmitted on path 106A will be processed by the associated or “tagged” CPU core 202A. Hence, the term “tagged,” as used herein, refers to identifying the particular CPU core (e.g., CPU core 202A) that will process the requests being transmitted on the associated input/output connection 106 (e.g., input/output connection 106A). It is noted that the notation (“/”) in the phrase “input/output,” as used herein, refers to “or.” Hence, the phrase “input/output,” as used herein, refers to “input or output.”

As further illustrated in FIG. 2, path 106B includes input/output queue 201C (identified as “I/O Queue 3” in FIG. 2) tagged to CPU core 202B (identified as “CPU Core 2” in FIG. 2) of storage system 103. Path 106C includes input/output queue 201D (identified as “I/O Queue 4” in FIG. 2) tagged to CPU core 202C (identified as “CPU Core 3” in FIG. 2).

As discussed above, in one embodiment, paths 106, such as paths 106A-106C, may be logical and/or physical input/output connections. Input/output queues 201A-201D may collectively or individually be referred to as input/output queues 201 or input/output queue 201, respectively. CPU cores 202A-202C may collectively or individually be referred to as CPU cores 202 or CPU core 202, respectively.

Input/output queues 201, as used herein, refer to an abstract data type that hold input/output requests. For example, input/output queue 201 may temporarily store the request from non-relational database system 102 to retrieve an object requested by AI application 101 from storage system 103 (e.g., disk volume 105A).

CPU core 202, as used herein, refers to the individual processing units within the storage system's central processing unit.

While FIG. 2 illustrates four input/output queues 201, the present disclosure is not to be limited in scope to such an embodiment. Each path 106 may include any number of input/output queues 201 and there may be any number of paths 106 between non-relational database system 102 and a disk volume 105 of storage system 103. Furthermore, while FIG. 2 illustrates three CPU cores 202 in storage system 103, the present disclosure is not to be limited in scope to such an embodiment. Storage system 103 may include any number of CPU cores 202.

Returning to FIG. 1, in conjunction with FIG. 2, in one embodiment, non-relational database system 102 is configured to select one of these paths 106 as the I/O connection to send the request (response issued by non-relational database system 102 upon receipt of the query from AI application 101) to retrieve an object from storage system 103. In one embodiment, such a selection is based on the input/output access characteristics of paths 106, the core speed (clock speed) of the CPU cores 202 and the type of multilevel urgency.

In one embodiment, the input/output access characteristics are determined based on a pattern of input/output access characteristics over paths 106 using machine learning as discussed in further detail below.

The “type of multilevel urgency,” as used herein, refers to one of the levels of urgency of the request (e.g., read request) issued by non-relational database system 102. For example, in one embodiment, the levels of urgency of the request (e.g., read request) issued by non-relational database system 102 include urgent, critical and super-critical, where the critical classification is assigned to a request that is more important to be processed than a request assigned the urgent classification and where the super-critical classification is assigned to a request that is more important to be processed than a request assigned the critical classification. In one embodiment, such a type of multilevel urgency is determined based on obtaining the urgency information pertaining to the query (requesting to retrieve an object from storage system 103), such as the object category of the object requested to be retrieved, the type of application requesting to retrieve the object, etc.

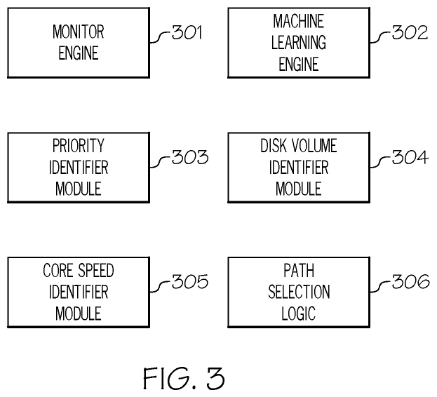

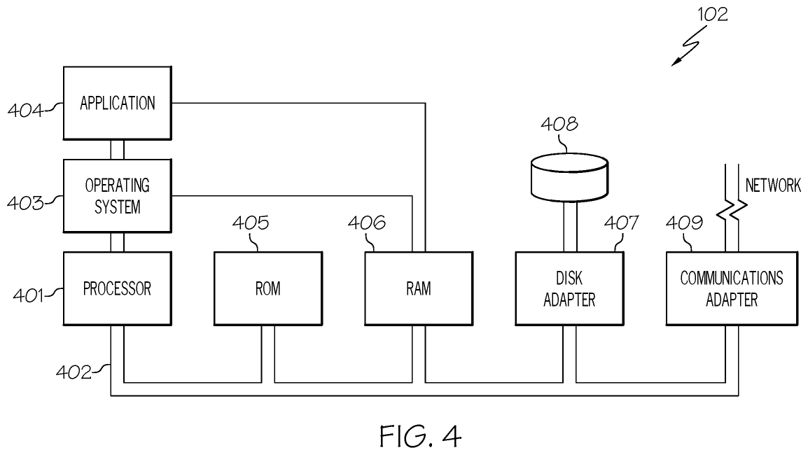

A more detailed description of these and other functions of non-relational database system 102 is provided further below. Furthermore, a description of the software components of non-relational database system 102 is provided below in connection with FIG. 3 and a description of the hardware configuration of non-relational database system 102 is provided further below in connection with FIG. 4.

System 100 is not to be limited in scope to any one particular network architecture. System 100 may include any number of AI applications 101, non-relational database systems 102, storage systems 103, hybrid cloud environments 104, disk volumes 105 and paths 106.

A discussion regarding the software components used by non-relational database system 102 to utilize the multiple input/output connections 106 in which the query urgency (urgency of the query issued by AI application 101) is propagated to storage system 103 along one of these input/output connections 106 is provided below in connection with FIG. 3. As will be discussed in greater detail below, such an urgency is propagated to storage system 103 based on assigning the appropriate level of urgency to the request issued by non-relational database system 102 to storage system 103.

FIG. 3 is a diagram of the software components of non-relational database system 102 used to select one of the input/output connections 106 between non-relational database system 102 and storage system 103 to send the request issued by non-relational database system 102 to storage system 103 with the appropriate level of urgency in accordance with an embodiment of the present disclosure.

As illustrated in FIG. 3, in conjunction with FIGS. 1-2, non-relational database system 102 includes a monitor engine 301 configured to collect input/output statistics from each of the paths 106 between non-relational database system 102 and storage system 103 to assess the input/output workload and the latency of the respective paths 106. “Input/output workload,” as used herein, refers to the amount of input gathered by input/output connection 106 and the amount of output produced by input/output connection 106 over a particular duration of time. “Latency,” as used herein, refers to a time delay. Input/output statistics include, but not limited to, input/output latency, bandwidth, response time, packet drops, congestion, etc.

In one embodiment, monitor engine 301 assesses the input/output workload by identifying the input/output access pattern on the input/output connections 106, such as the number of read and write requests. Examples of software tools utilized by monitor engine 301 to assess the input/output workload by identifying the input/output access pattern on the input/output connections 106, include, but not limited to, Iometer, Condusiv® I/O Assessment Tool, etc.

In one embodiment, monitor engine 301 assesses the input/output latency of input/output connections 106 by measuring the time it takes for a request to travel from one point to another and for a response to be sent back to the source (e.g., non-relational database system 102). Such a measure is referred to as the “round-trip time.” In another embodiment, monitor engine 301 records the time it takes from the moment a request leaves a point to arrive at its destination. Such a measurement is referred to as “time to first byte.” In such an embodiment, a data collection software is installed on the destination point (e.g., storage system 103).

Examples of software tools utilized by monitor engine 301 to collect input/output statistics, such as input/output latency, from each of the paths 106 between non-relational database system 102 and storage system 103 to assess the input/output workload and the latency of the respective paths 106, include, but not limited to, SolarWinds® Network Performance Monitor, SolarWinds® NetFlow Traffic Analyzer, Angry IP Scanner, SolarWinds® Engineer's Toolset™, Paessler® PRTG Network Monitor, NetScanTools®, Amazon® CloudWatch®, etc.

In one embodiment, monitor engine 301 measures the bandwidth (maximum rate of data transfer across a given path) of input/output connections 106.

Examples of software tools utilized by monitor engine 301 to measure the bandwidth of input/output connections 106 include, but not limited to, SolarWinds® Network Performance Monitor, SolarWinds® NetFlow Traffic Analyzer, Paessler® PRTG Network Monitor, N-able™ Remote Monitoring & Management, etc.

In one embodiment, monitor engine 301 measures the response time of input/output connections 106. The “response time,” as used herein, refers to the length of time it takes to complete an input/output operation. Examples of software tools utilized by monitor engine 301 to measure the response time of input/output connections 106, include, but not limited to, SolarWinds® Engineer's Toolset™, Amazon® CloudWatch®, Dynatrace®, ManageEngine® Applications Manager, etc.

In one embodiment, monitor engine 301 measures the packet drops across input/output connections 106. A “packet drop,” as used herein, refers to a packet that has been delayed or misplaced. Examples of software tools utilized by monitor engine 301 to measure packet drops across input/output connections 106, include, but not limited to, SolarWinds® Network Quality Manager, SolarWinds® Network Performance Monitor, Paessler® PRTG Network Monitor, Packet Loss Test™, etc.

In one embodiment, monitor engine 301 measures the congestion in input/output connections 106. “Congestion,” as used herein, refers to the reduced quality of service that occurs when the connection is carrying more data than it can handle. Examples of software tools utilized by monitor engine 301 to measure congestion across input/output connections 106, include, but not limited to, SolarWinds® NetFlow Traffic Analyzer, Wireshark®, Cacti®, LogicMonitor®, Datadog®, Dynatrace®, etc.

Non-relational database system 102 further includes a machine learning engine 302 configured to build a pattern of input/output access characteristics for each path 106 using the collected input/output statistics from monitor engine 301. In one embodiment, machine learning engine 302 utilizes a machine learning algorithm to build a pattern of input/output access characteristics over each path 106 using the collected input/output statistics from monitor engine 301.

The “pattern” of input/output access characteristics over a path 106, as used herein, refers to the input/output access statistics that are typically exhibited by path 106, such as based on the input/output workload being serviced by path 106, particular time of day, etc. Such a pattern is based on the input/output statistics (used to assess the input/output workload and the latency of the respective path 106) collected from monitor engine 301, which is used as “training data” to train a mathematical model to predict the input/output access characteristics of a path 106, such as based on the input/output workload being processed, etc. In one embodiment, such a pattern of input/output characteristics corresponds to values corresponding to different fields of input/output access characteristics. For example, in the pattern of 0.3 milliseconds, 15 KHz, 5 milliseconds, 1 and 0, 0.3 milliseconds corresponds to the input/output latency, 15 KHz corresponds to the bandwidth, 5 milliseconds corresponds to the response time, 1 corresponds to the number of packet drops over a period of 1 hour and 0 corresponds to the lack of existence of congestion.

In one embodiment, machine learning engine 302 uses a machine learning algorithm (e.g., supervised learning) to build a mathematical model based on sample data consisting of input/output statistics (used to assess the input/output workload and the latency of the respective path 106) collected from monitor engine 301. Such a data set is referred to herein as the “training data” which is used by the machine learning algorithm to make predictions or decisions of the input/output access characteristics of a path 106 without being explicitly programmed to perform the task. In one embodiment, the training data consists of input/output statistics based on an input/output workload being processed, time of day, types of queries being processed, etc. The algorithm iteratively makes predictions on the training data as to the input/output access characteristics over each path 106. Examples of such supervised learning algorithms include nearest neighbor, Naïve Bayes, decision trees, linear regression, support vector machines and neural networks.

In one embodiment, the mathematical model (machine learning model) corresponds to a classification model trained to predict the input/output access characteristics over each path 106.

Non-relational database system 102 further includes a priority identifier module 303 configured to determine the type of multilevel urgency (type of input/output level priority) exhibited by the query received by non-relational database system 102 from AI application 101 to retrieve an object from storage system 103. An “object,” as used herein, refers to data that is stored in storage system 103, where the data in the form of “objects” are stored on flat address space based on its content and other attributes rather than the file name and the location.

Such a level of urgency in the received query is reflected in the urgency of the request issued by non-relational database system 102 to read the requested object from storage system 103.

The “type of multilevel urgency,” as used herein, refers to one of the levels of urgency of the request (e.g., read request) issued by non-relational database system 102 to read the requested object from storage system 103. For example, in one embodiment, the levels of urgency of the request (e.g., read request) issued by non-relational database system 102 include urgent, critical and super-critical, where the critical classification is assigned to a request that is more important to be processed than a request assigned the urgent classification and where the super-critical classification is assigned to a request that is more important to be processed than a request assigned the critical classification. In one embodiment, such a type of multilevel urgency is determined based on obtaining the urgency information pertaining to the query (requesting to retrieve an object from storage system 103), such as the object category of the object requested to be retrieved, the type of application requesting to retrieve the object, etc.

In one embodiment, priority identifier module 303 obtains the urgency information pertaining to the query received by non-relational database system 102. In one embodiment, such urgency information includes the object category of the object requested to be retrieved. For example, in one embodiment, priority identifier module 303 may analyze the query to determine the type of object to be retrieved, such as the type of data (e.g., metadata, supervised data, analytics data, visual data, textual data, numerical data, etc.). For example, in one embodiment, the query may contain metadata that describes the type of object (data) being requested. Such a description is then used to identify the “object category” from a data structure (e.g., table) storing a listing of types of objects and their associated object category. In one embodiment, such a data structure is populated by an expert. In one embodiment, such a data structure is stored in the storage device of non-relational database system 102 (e.g., memory, disk unit). In one embodiment, priority identifier module 303 utilizes natural language processing to identify the matching type of object in the data structure to locate its associated object category.

Upon identifying the object category, in one embodiment, priority identifier module 303 identifies a type of multilevel urgency in the request (request to retrieve the object) to be issued by non-relational database system 102 based on identifying the object category in a data structure (e.g., table) storing a listing of object categories (e.g., metadata) and their associated multilevel urgencies (e.g., super-critical). For example, upon identifying the object category in such a data structure, the associated multilevel urgency in the request to be issued by non-relational database system 102 may then be obtained. In one embodiment, such a data structure is populated by an expert. In one embodiment, such a data structure is stored in the storage device of non-relational database system 102 (e.g., memory, disk unit). In one embodiment, priority identifier module 303 utilizes natural language processing to identify the matching object category in the data structure to locate its associated multilevel urgency in the request to be issued by non-relational database system 102.

In one embodiment, priority identifier module 303 identifies a type of multilevel urgency in the request (request to retrieve the object) to be issued by non-relational database system 102 based on identifying the type of AI application 101 issuing the query. For example, AI applications 101 may involve applications of AI in various aspects, such as e-commerce, navigation, robotics, human resource, healthcare, agriculture, gaming, automobiles, social media, marketing, etc. In one embodiment, the type of AI application (e.g., gaming) is determined from its identifier (e.g., name). In one embodiment, the type of AI application 101 is used to identify a type of multilevel urgency in the request (request to retrieve the object) to be issued by non-relational database system 102 using a data structure (e.g., table) storing a listing of types of AI applications 101 (e.g., gaming) and their associated multilevel urgencies (e.g., critical). For example, upon identifying the type of AI application 101 in such a data structure, the associated multilevel urgency in the request to be issued by non-relational database system 102 may then be obtained. In one embodiment, such a data structure is populated by an expert. In one embodiment, such a data structure is stored in the storage device of non-relational database system 102 (e.g., memory, disk unit). In one embodiment, priority identifier module 303 utilizes natural language processing to identify the matching type of AI application 101 in the data structure to locate its associated multilevel urgency in the request to be issued by non-relational database system 102.

Non-relational database system 102 further includes a disk volume identifier module 304 configured to identify a disk volume 105 from a record (e.g., an object dictionary record) of the requested object, such as an identifier (e.g., label) that is associated with such a disk volume 105. The “requested object,” as used herein, refers to the object requested to be retrieved by AI application 101. In one embodiment, a data structure (e.g., table) stores a record associated with such an object that indicates its storage location within storage system 103, such as a particular disk volume 105 of storage system 103. Such records are referred to herein as “object dictionary records.” In one embodiment, such a data structure is stored in the storage device of non-relational database system 102 (e.g., memory, disk unit).

Non-relational database system 102 further includes a core speed identifier module 305 configured to identify the CPU core speed of CPU cores 202 of storage system 103 at a particular moment in time, such as when a path 106 (e.g., logical or physical input/output connection) is to be selected to send a request (e.g., read request) from non-relational database system 102 to storage system 103. “CPU core speed,” as used herein, refers to the clock speed (operating speed) of the CPU core 202. In one embodiment, the CPU core speed is obtained by core speed identifier module 305 at the time of initializing input/output queue 201. Examples of software tools utilized by core speed identifier module 305 to measure the CPU core speed of CPU cores 202, include, but not limited to, CPUID HWMonitor, SolarWinds® Server & Application Monitor, Paessler® PRTG Network Monitor, SysGauge, etc.

Furthermore, non-relational database system 102 includes a path selection logic 306 configured to select the path 106 (e.g., logical or physical input/output connection) to be used to send a request (e.g., read request) from non-relational database system 102 to storage system 103 in which the query urgency is propagated to storage system 103 along such a selected path 106.

In one embodiment, path selection logic 306 is configured to identify the logical or physical connections 106 extending from non-relational database system 102 to the identified disk volume 105 of storage system 103 (identified by disk volume identifier module 304).

In one embodiment, path selection logic 306 identifies the logical and/or physical connections 106 extending from non-relational database system 102 to the identified disk volume 105 of storage system 103 based on identifying such connections 106 in a data structure (e.g., table) that stores a listing of the logical and/or physical connections 106 that are connected to particular disk volumes 105 of storage system 103. In one embodiment, such disk volumes 105 are identified by identifiers (e.g., labels). As a result, after obtaining the identifier for disk volume 105 identified by disk volume identifier module 304, path selection logic 306 is able to identify the logical and/or physical connections 106 that are connected to such a disk volume 105 based on locating the identified disk volume 105 in the data structure discussed above. In one embodiment, such a data structure is populated by an expert. In one embodiment, such a data structure is stored in the storage device of non-relational database system 102 (e.g., memory, disk unit). In one embodiment, path selection logic 306 utilizes natural language processing to identify the matching disk volume identifier (e.g., label) in the data structure to locate the logical and/or physical connections 106 that are connected to such a disk volume 105.

In one embodiment, path selection logic 306 is configured to select a path 106 (one of the logical and/or physical connections that are identified as being connected to the identified disk volume 105 of storage system 103) based on the pattern of the input/output access characteristics, the CPU core speeds for the CPU cores 202 and the determined level of urgency for the retrieval of the object. As discussed above, the pattern of the input/output access characteristics is generated by machine learning engine 302. Furthermore, as discussed above, the CPU core speed for the CPU cores 202 is determined by core speed identifier module 305. Additionally, as discussed above, the determined level of urgency for the retrieval of the object is determined by priority identifier module 303. Based on such information, path selection logic 306 selects path 106 from non-relational database system 102 to the identified disk volume 105 with the appropriate input/output access characteristics that satisfy the requirements of the level of urgency for the retrieval of the object.

In one embodiment, a data structure (e.g., table) stores a mapping of the level of urgency (type of multilevel urgency) to a required pattern of input/output access characteristics that needs to be possessed by the selected input/output connection 106, such as a range of input/output latency, bandwidth, response time, number of packet drops, existence of congestion, etc. For example, for the “critical” type of urgency, the following pattern of input/output access characteristics (in terms of values) are mapped to such a level of urgency: 02 to 1.5 milliseconds (range of acceptable input/output latency); 15 to 20 KHz (range of acceptable bandwidth); five to 10 milliseconds (range of acceptable response times); 1 (number of acceptable packet drops over a period of 1 hour); and 0 (no existence of congestion). In one embodiment, such a data structure is populated by an expert. In one embodiment, such a data structure is stored in the storage device of non-relational database system 102 (e.g., memory, disk unit).

Furthermore, in one embodiment, a data structure (e.g., table) stores a mapping of the level of urgency (type of multilevel urgency) to a range of CPU core speeds for CPU cores 202. For example, for the “critical” type of urgency, the range of CPU core speeds for CPU cores 202 is 3.5 GHz to 4.0 GHz. In one embodiment, such a data structure is populated by an expert. In one embodiment, such a data structure is stored in the storage device of non-relational database system 102 (e.g., memory, disk unit).

Based on the level of urgency (type of multilevel urgency) for the retrieval of the object as determined by priority identifier module 303, path selection logic 306 identifies the pattern of input/output access characteristics as well as identifies the range of CPU core speeds for CPU cores 202 matching such a level of urgency in the data structures discussed above.

Afterwards, path selection logic 306 identifies a path 106 (e.g., logical or physical connection) out of the identified logical and/or physical connections that are connected to the identified disk volume 105 with input/output access characteristics (obtained from machine learning engine 302) that match or most closely matches the input/output access characteristics obtained from the data structure discussed above, where such an identified path is tagged to a CPU core 202 with a core speed (core speed obtained from core speed identifier module 305) that satisfies the range of CPU core speeds obtained from the data structure discussed above. For example, path 106B (one of the paths out of the identified logical and/or physical connections that are connected to the identified disk volume 105) may exhibit a pattern of input/output access characteristics (obtained from machine learning engine 302) that satisfies the input/output access requirements for the designated level of urgency (e.g., critical), which was obtained from the data structure discussed above. Furthermore, such a path (path 106B) may be tagged to a CPU core 202 (e.g., CPU core 202B) with a core speed (obtained from core speed identifier module 305) that satisfies the required range of CPU core speeds for the designated level of urgency (e.g., critical), which was obtained from the data structure discussed above. As a result, in such an example, path 106B would be selected by path selection logic 306 to be used to send a request (e.g., read request) from non-relational database system 102 to storage system 103 in which the urgency of the query is propagated to storage system 103 along such a selected path 106.

In one embodiment, in the scenario in which a path 106 is not identified that satisfies the input/output access requirements for the designated level of urgency (e.g., critical), path selection logic 306 selects the path that most closely satisfies the input/output access requirements for the designated level of urgency and is tagged to a CPU core 202 that satisfies or most closely satisfies the required range of CPU core speeds for the designated level of urgency (e.g., critical).

A further description of these and other functions is provided below in connection with the discussion of the method for managing queries to non-relational databases.

Prior to the discussion of the method for managing queries to non-relational databases, a description of the hardware configuration of non-relational database system 102 (FIG. 1) is provided below in connection with FIG. 4.

Referring now to FIG. 4, FIG. 4 illustrates an embodiment of the present disclosure of the hardware configuration of non-relational database 102 (FIG. 1) which is representative of a hardware environment for practicing the present disclosure.

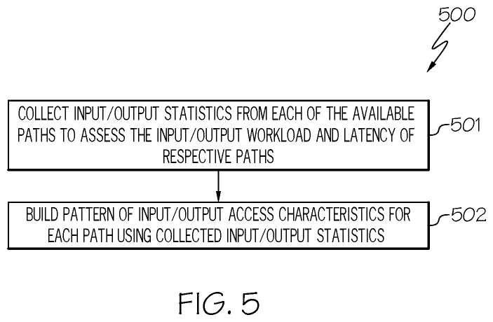

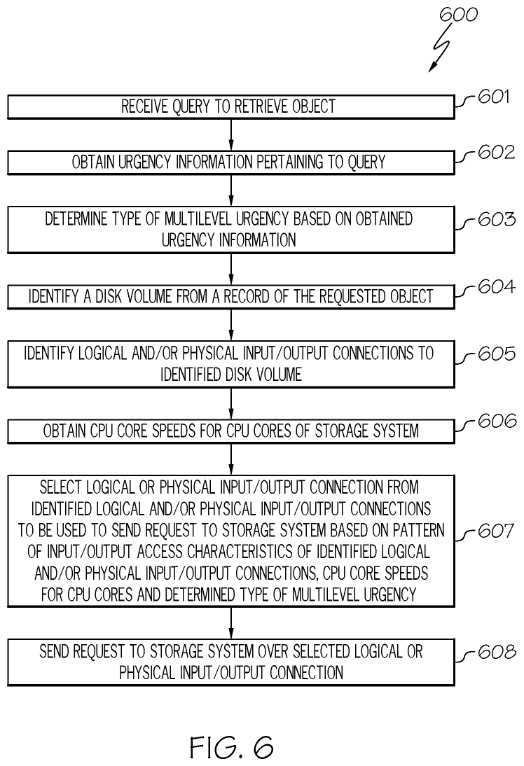

Non-relational database system 102 has a processor 401 connected to various other components by system bus 402. An operating system 403 runs on processor 401 and provides control and coordinates the functions of the various components of FIG. 4. An application 404 in accordance with the principles of the present disclosure runs in conjunction with operating system 403 and provides calls to operating system 403 where the calls implement the various functions or services to be performed by application 404. Application 404 may include, for example, monitor engine 301 (FIG. 3), machine learning engine 302 (FIG. 3), priority identifier module 303 (FIG. 3), disk volume identifier module 304 (FIG. 3), core speed identifier module 305 (FIG. 3) and path selection logic 306 (FIG. 3). Furthermore, application 404 may include, for example, a program for managing queries to non-relational database systems as discussed further below in connection with FIGS. 5-6.

Referring again to FIG. 4, read-only memory (“ROM”) 405 is connected to system bus 402 and includes a basic input/output system (“BIOS”) that controls certain basic functions of non-relational database system 102. Random access memory (“RAM”) 406 and disk adapter 407 are also connected to system bus 402. It should be noted that software components including operating system 403 and application 404 may be loaded into RAM 406, which may be non-relational database system's 102 main memory for execution. Disk adapter 407 may be an integrated drive electronics (“IDE”) adapter that communicates with a disk unit 408, e.g., disk drive. It is noted that the program for managing queries to non-relational database systems, as discussed further below in connection with FIGS. 5-6, may reside in disk unit 408 or in application 404.

Non-relational database system 102 may further include a communications adapter 409 connected to bus 402. Communications adapter 409 interconnects bus 402 with an outside network (e.g., hybrid cloud environment 104) to communicate with other devices, such as storage system 103 (FIG. 1).

In one embodiment, application 404 of non-relational database system 102 includes the software components of monitor engine 301, machine learning engine 302, priority identifier module 303, disk volume identifier module 304, core speed identifier module 305 and path selection logic 306. In one embodiment, such components may be implemented in hardware, where such hardware components would be connected to bus 402. The functions discussed above performed by such components are not generic computer functions. As a result, non-relational database system 102 is a particular machine that is the result of implementing specific, non-generic computer functions.

In one embodiment, the functionality of such software components (e.g., monitor engine 301, machine learning engine 302, priority identifier module 303, disk volume identifier module 304, core speed identifier module 305 and path selection logic 306) of non-relational database system 102, including the functionality for managing queries, may be embodied in an application specific integrated circuit.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

As stated above, a transmission protocol, such as NVMe (non-volatile memory express), may be utilized for accessing non-volatile storage media, such as the non-volatile storage media in the storage system connected to a non-relational database, such as a NoSQL database. Using such technology may result in many input/output connections being created over a single physical connection to gain the benefits of parallelizing input/output connections. As a result, a NoSQL disk volume may have multiple paths (“multipath”), each path having one or more input/output queues which are tagged to a dissimilar CPU core in the storage system. In such a scenario, there could be clock speed differences between the CPU cores which can affect the input/output performance when requested on certain paths. Unfortunately, NVMe based standards have no multipath policy. As a result, the NoSQL database cannot obtain information about the multiple input/output connections created for the same disk volumes. Furthermore, if an application, such as AI application, issues a query desiring to retrieve an object (e.g., JSON object) urgently (requiring immediate retrieval) from the storage system, there is not currently a means for propagating such a query urgency (e.g., retrieval urgency) to the storage system, such as over one of these input/output connections, due to the operational differences between the NoSQL database and the storage system. Hence, there is not currently a means for NoSQL databases to utilize the multiple input/output connections created in a multi-connection input/output transmission protocol (e.g., NVMe) as well as propagate a query urgency to the storage system, such as via one of these input/output connections.

The embodiments of the present disclosure provide a means for a non-relational database (e.g., NoSQL database) to utilize the multiple input/output connections created in a multi-connection input/output transmission protocol (e.g., NVMe) in which the query urgency is propagated to the storage system along one of these input/output connections as discussed below in connection with FIGS. 5 and 6. FIG. 5 is a flowchart of a method for building a pattern of input/output access characteristics over each path between the non-relational database system and its storage system. FIG. 6 is a flowchart of a method for managing queries to a non-relational database system by utilizing the multiple input/output connections to the storage system in which the query urgency is propagated to the storage system along one of these input/output connections.

As stated above, FIG. 5 is a flowchart of a method 500 for building a pattern of input/output access characteristics over each path between non-relational database system 102 (FIGS. 1 and 2) and its storage system 103 (FIGS. 1 and 2) in accordance with an embodiment of the present disclosure.

Referring now to FIG. 5, in conjunction with FIGS. 1-4, in operation 501, monitor engine 301 of non-relational database system 102 collects input/output statistics from each of the available paths 106 that extend from non-relational database system 102 to virtual disks 105 of storage system 103 via a hybrid cloud environment 104 to assess the input/output workload and the latency of the respective paths 106.

As discussed above, “input/output workload,” as used herein, refers to the amount of input gathered by input/output connection 106 and the amount of output produced by input/output connection 106 over a particular duration of time. “Latency,” as used herein, refers to a time delay. Input/output statistics include, but not limited to, input/output latency, bandwidth, response time, packet drops, congestion, etc.

In one embodiment, monitor engine 301 assesses the input/output workload by identifying the input/output access pattern on the input/output connections 106, such as the number of read and write requests. Examples of software tools utilized by monitor engine 301 to assess the input/output workload by identifying the input/output access pattern on the input/output connections 106, include, but not limited to, Iometer, Condusiv® I/O Assessment Tool, etc.

In one embodiment, monitor engine 301 assesses the input/output latency of input/output connections 106 by measuring the time it takes for a request to travel from one point to another and for a response to be sent back to the source (e.g., non-relational database system 102). Such a measure is referred to as the “round-trip time.” In another embodiment, monitor engine 301 records the time it takes from the moment a request leaves a point to arrive at its destination. Such a measurement is referred to as “time to first byte.” In such an embodiment, a data collection software is installed on the destination point (e.g., storage system 103).

Examples of software tools utilized by monitor engine 301 to collect input/output statistics, such as input/output latency, from each of the paths 106 between non-relational database system 102 and storage system 103 to assess the input/output workload and the latency of the respective paths 106, include, but not limited to, SolarWinds® Network Performance Monitor, SolarWinds® NetFlow Traffic Analyzer, Angry IP Scanner, SolarWinds® Engineer's Toolset™, Paessler® PRTG Network Monitor, NetScanTools®, Amazon® CloudWatch®, etc.

In one embodiment, monitor engine 301 measures the bandwidth (maximum rate of data transfer across a given path) of input/output connections 106.

Examples of software tools utilized by monitor engine 301 to measure the bandwidth of input/output connections 106 include, but not limited to, SolarWinds® Network Performance Monitor, SolarWinds® NetFlow Traffic Analyzer, Paessler® PRTG Network Monitor, N-able™ Remote Monitoring & Management, etc.

In one embodiment, monitor engine 301 measures the response time of input/output connections 106. The “response time,” as used herein, refers to the length of time it takes to complete an input/output operation. Examples of software tools utilized by monitor engine 301 to measure the response time of input/output connections 106, include, but not limited to, SolarWinds® Engineer's Toolset™, Amazon® CloudWatch®, Dynatrace®, ManageEngine® Applications Manager, etc.

In one embodiment, monitor engine 301 measures the packet drops across input/output connections 106. A “packet drop,” as used herein, refers to a packet that has been delayed or misplaced. Examples of software tools utilized by monitor engine 301 to measure packet drops across input/output connections 106, include, but not limited to, SolarWinds® Network Quality Manager, SolarWinds® Network Performance Monitor, Paessler® PRTG Network Monitor, Packet Loss Test™, etc.

In one embodiment, monitor engine 301 measures the congestion in input/output connections 106. “Congestion,” as used herein, refers to the reduced quality of service that occurs when the connection is carrying more data than it can handle. Examples of software tools utilized by monitor engine 301 to measure congestion across input/output connections 106, include, but not limited to, SolarWinds® NetFlow Traffic Analyzer, Wireshark®, Cacti®, LogicMonitor®, Datadog®, Dynatrace®, etc.

In operation 502, machine learning engine 302 of non-relational database system 102 builds a pattern of input/output access characteristics for each path 106 using the collected input/output statistics.

As discussed above, the “pattern” of input/output access characteristics over a path 106, as used herein, refers to the input/output access statistics that are typically exhibited by path 106, such as based on the input/output workload being serviced by path 106, particular time of day, etc. Such a pattern is based on the input/output statistics (used to assess the input/output workload and the latency of the respective path 106) collected from monitor engine 301, which is used as “training data” to train a mathematical model to predict the input/output access characteristics of a path 106, such as based on the input/output workload being processed, etc. In one embodiment, such a pattern of input/output characteristics corresponds to values corresponding to different fields of input/output access characteristics. For example, in the pattern of 0.3 milliseconds, 15 KHz, 5 milliseconds, 1 and 0, 0.3 milliseconds corresponds to the input/output latency, 15 KHz corresponds to the bandwidth, 5 milliseconds corresponds to the response time, 1 corresponds to the number of packet drops over a period of 1 hour and 0 corresponds to the lack of existence of congestion.

In one embodiment, machine learning engine 302 uses a machine learning algorithm (e.g., supervised learning) to build a mathematical model based on sample data consisting of input/output statistics (used to assess the input/output workload and the latency of the respective path 106) collected from monitor engine 301. Such a data set is referred to herein as the “training data” which is used by the machine learning algorithm to make predictions or decisions of the input/output access characteristics of a path 106 without being explicitly programmed to perform the task. In one embodiment, the training data consists of input/output statistics based on an input/output workload being processed, time of day, types of queries being processed, etc. The algorithm iteratively makes predictions on the training data as to the input/output access characteristics over each path 106. Examples of such supervised learning algorithms include nearest neighbor, Naïve Bayes, decision trees, linear regression, support vector machines and neural networks.

In one embodiment, the mathematical model (machine learning model) corresponds to a classification model trained to predict the input/output access characteristics over each path 106.

Based on determining the pattern of input/output access characteristics for each path 106, non-relational database system 102 selects the appropriate path 106 (input/output connection) to send the request (e.g., read request) to storage system 103 in which the urgency of the query (query urgency) is propagated to storage system 103 along the selected path 106 (input/output connection) as discussed below in connection with FIG. 6.

FIG. 6 is a flowchart of a method 600 for managing queries to non-relational database system 102 (FIGS. 1 and 2) by utilizing the multiple input/output connections 106 (FIGS. 1 and 2) to storage system 103 (FIGS. 1 and 2) in which the query urgency is propagated to storage system 103 along one of these input/output connections 106 in accordance with an embodiment of the present disclosure.

Referring to FIG. 6, in conjunction with FIGS. 1-5, in operation 601, non-relational database system 102 receives a query from AI application 101 to retrieve an object from storage system 103.

As discussed above, in one embodiment, storage system 103 is an object based storage system, in which data is stored in the form of “objects” in storage system 103 on flat address space based on its content and other attributes rather than the file name and the location. In one embodiment, each object stored in storage system 103 is identified by a unique identifier called an “object ID.” The object ID allows easy access to objects without the need to specify the storage location.

In operation 602, priority identifier module 303 of non-relational database system 102 obtains the urgency information pertaining to the query. In one embodiment, such urgency information includes the object category of the object requested to be retrieved as well as the type of application 101 requesting to retrieve the object.

In operation 603, priority identifier module 303 of non-relational database system 102 determines the level of urgency for the retrieval of the object based on the obtained urgency information. Such a “level of urgency” refers to the type of multilevel urgency (type of input/output level priority) exhibited by the query received by non-relational database system 102 from AI application 101 to retrieve an object from storage system 103.

As stated above, such a level of urgency in the received query is reflected in the urgency of the request issued by non-relational database system 102 to read the requested object from storage system 103.

The “type of multilevel urgency,” as used herein, refers to one of the levels of urgency of the request (e.g., read request) issued by non-relational database system 102 to read the requested object from storage system 103. For example, in one embodiment, the levels of urgency of the request (e.g., read request) issued by non-relational database system 102 include urgent, critical and super-critical, where the critical classification is assigned to a request that is more important to be processed than a request assigned the urgent classification and where the super-critical classification is assigned to a request that is more important to be processed than a request assigned the critical classification. In one embodiment, such a type of multilevel urgency is determined based on obtaining the urgency information pertaining to the query (requesting to retrieve an object from storage system 103), such as the object category of the object requested to be retrieved, the type of application requesting to retrieve the object, etc.

In one embodiment, priority identifier module 303 obtains the urgency information pertaining to the query received by non-relational database system 102. In one embodiment, such urgency information includes the object category of the object requested to be retrieved. For example, in one embodiment, priority identifier module 303 may analyze the query to determine the type of object to be retrieved, such as the type of data (e.g., metadata, supervised data, analytics data, visual data, textual data, numerical data, etc.). For example, in one embodiment, the query may contain metadata that describes the type of object (data) being requested. Such a description is then used to identify the “object category” from a data structure (e.g., table) storing a listing of types of objects and their associated object category. In one embodiment, such a data structure is populated by an expert. In one embodiment, such a data structure is stored in the storage device of non-relational database system 102 (e.g., memory 405, disk unit 408). In one embodiment, priority identifier module 303 utilizes natural language processing to identify the matching type of object in the data structure to locate its associated object category.

Upon identifying the object category, in one embodiment, priority identifier module 303 identifies a type of multilevel urgency in the request (request to retrieve the object) to be issued by non-relational database system 102 based on identifying the object category in a data structure (e.g., table) storing a listing of object categories (e.g., metadata) and their associated multilevel urgencies (e.g., super-critical). For example, upon identifying the object category in such a data structure, the associated multilevel urgency in the request to be issued by non-relational database system 102 may then be obtained. In one embodiment, such a data structure is populated by an expert. In one embodiment, such a data structure is stored in the storage device of non-relational database system 102 (e.g., memory 405, disk unit 408). In one embodiment, priority identifier module 303 utilizes natural language processing to identify the matching object category in the data structure to locate its associated multilevel urgency in the request to be issued by non-relational database system 102.

In one embodiment, priority identifier module 303 identifies a type of multilevel urgency in the request (request to retrieve the object) to be issued by non-relational database system 102 based on identifying the type of AI application 101 issuing the query. For example, AI applications 101 may involve applications of AI in various aspects, such as e-commerce, navigation, robotics, human resource, healthcare, agriculture, gaming, automobiles, social media, marketing, etc. In one embodiment, the type of AI application (e.g., gaming) is determined from its identifier (e.g., name). In one embodiment, the type of AI application 101 is used to identify a type of multilevel urgency in the request (request to retrieve the object) to be issued by non-relational database system 102 using a data structure (e.g., table) storing a listing of types of AI applications 101 (e.g., gaming) and their associated multilevel urgencies (e.g., critical). For example, upon identifying the type of AI application 101 in such a data structure, the associated multilevel urgency in the request to be issued by non-relational database system 102 may then be obtained. In one embodiment, such a data structure is populated by an expert. In one embodiment, such a data structure is stored in the storage device of non-relational database system 102 (e.g., memory 405, disk unit 408). In one embodiment, priority identifier module 303 utilizes natural language processing to identify the matching type of AI application 101 in the data structure to locate its associated multilevel urgency in the request to be issued by non-relational database system 102.

In operation 604, disk volume identifier module 304 of non-relational database system 102 identifies a disk volume from a record of the requested object, such as an identifier (e.g., label) that is associated with such a disk volume.

As stated above, disk volume identifier module 304 identifies a disk volume 105 from a record (e.g., an object dictionary record) of the requested object, such as an identifier (e.g., label) that is associated with such a disk volume 105. The “requested object,” as used herein, refers to the object requested to be retrieved by AI application 101. In one embodiment, a data structure (e.g., table) stores a record associated with such an object that indicates its storage location within storage system 103, such as a particular disk volume 105 of storage system 103. Such records are referred to herein as “object dictionary records.” In one embodiment, such a data structure is stored in the storage device of non-relational database system 102 (e.g., memory 405, disk unit 408).

In operation 605, path selection logic 306 of non-relational database system 102 identifies the logical and/or physical connections 105 extending from non-relational database system 102 to the identified disk volume 105 of storage system 103.

As stated above, in one embodiment, path selection logic 306 identifies the logical and/or physical connections 106 extending from non-relational database system 102 to the identified disk volume 105 of storage system 103 (identified in operation 604) based on identifying such connections 106 in a data structure (e.g., table) that stores a listing of the logical and/or physical connections 106 that are connected to particular disk volumes 105 of storage system 103. In one embodiment, such disk volumes 105 are identified by identifiers (e.g., labels). As a result, after obtaining the identifier for disk volume 105 identified by disk volume identifier module 304 in operation 604, path selection logic 306 is able to identify the logical and/or physical connections 106 that are connected to such a disk volume 105 based on locating the identified disk volume 105 in the data structure discussed above. In one embodiment, such a data structure is populated by an expert. In one embodiment, such a data structure is stored in the storage device of non-relational database system 102 (e.g., memory 405, disk unit 408). In one embodiment, path selection logic 306 utilizes natural language processing to identify the matching disk volume identifier (e.g., label) in the data structure to locate the logical and/or physical connections 106 that are connected to such a disk volume 105.

In operation 606, core speed identifier module 305 of non-relational database system 102 identifies the CPU core speed of CPU cores 202 of storage system 103 at a particular moment in time, such as when a path 106 (e.g., logical or physical input/output connection) is to be selected to send a request (e.g., read request) from non-relational database system 102 to storage system 103.

As stated above, “CPU core speed,” as used herein, refers to the clock speed (operating speed) of the CPU core 202. In one embodiment, the CPU core speed is obtained by core speed identifier module 305 at the time of initializing input/output queue 201. Examples of software tools utilized by core speed identifier module 305 to measure the CPU core speed of CPU cores 202, include, but not limited to, CPUID HWMonitor, SolarWinds® Server & Application Monitor, Paessler® PRTG Network Monitor, SysGauge, etc.

In operation 607, path selection logic 306 of non-relational database system 102 selects one of the identified logical and/or physical input/output connections 106 (identified in operation 605) to be used to send the request (e.g., read request) to storage system 103 from non-relational database system 102 across hybrid cloud environment 104 based on the pattern of input/output access characteristics of the identified logical and/or physical input/output connections 106 (obtained in operation 502), the CPU core speeds for CPU cores 202 (obtained in operation 606) and the determined type of multilevel urgency (obtained in operation 603).

As discussed above, the pattern of the input/output access characteristics is generated by machine learning engine 302. Furthermore, as discussed above, the CPU core speed for the CPU cores 202 is determined by core speed identifier module 305. Additionally, as discussed above, the determined level of urgency for the retrieval of the object is determined by priority identifier module 303. Based on such information, path selection logic 306 selects path 106 from non-relational database system 102 to the identified disk volume 105 with the appropriate input/output access characteristics that satisfy the requirements of the level of urgency for the retrieval of the object.

In one embodiment, a data structure (e.g., table) stores a mapping of the level of urgency (type of multilevel urgency) to a required pattern of input/output access characteristics that needs to be possessed by the selected input/output connection 106, such as a range of input/output latency, bandwidth, response time, number of packet drops, existence of congestion, etc. For example, for the “critical” type of urgency, the following pattern of input/output access characteristics (in terms of values) are mapped to such a level of urgency: 02 to 1.5 milliseconds (range of acceptable input/output latency); 15 to 20 KHz (range of acceptable bandwidth); five to 10 milliseconds (range of acceptable response times); 1 (number of acceptable packet drops over a period of 1 hour); and 0 (no existence of congestion). In one embodiment, such a data structure is populated by an expert. In one embodiment, such a data structure is stored in the storage device of non-relational database system 102 (e.g., memory 405, disk unit 408).

Furthermore, in one embodiment, a data structure (e.g., table) stores a mapping of the level of urgency (type of multilevel urgency) to a range of CPU core speeds for CPU cores 202. For example, for the “critical” type of urgency, the range of CPU core speeds for CPU cores 202 is 3.5 GHz to 4.0 GHz. In one embodiment, such a data structure is populated by an expert. In one embodiment, such a data structure is stored in the storage device of non-relational database system 102 (e.g., memory 405, disk unit 408).

Based on the level of urgency (type of multilevel urgency) for the retrieval of the object as determined by priority identifier module 303, path selection logic 306 identifies the pattern of input/output access characteristics as well as identifies the range of CPU core speeds for CPU cores 202 matching such a level of urgency in the data structures discussed above.

Afterwards, path selection logic 306 identifies a path 106 (e.g., logical or physical connection) out of the identified logical and/or physical connections that are connected to the identified disk volume 105 (obtained in operation 605) with input/output access characteristics (obtained from machine learning engine 302) that match or most closely matches the input/output access characteristics obtained from the data structure discussed above, where such an identified path is tagged to a CPU core 202 with a core speed (core speed obtained from core speed identifier module 305 in operation 606) that satisfies the range of CPU core speeds obtained from the data structure discussed above. For example, path 106B (one of the paths out of the identified logical and/or physical connections that are connected to the identified disk volume 105) may exhibit a pattern of input/output access characteristics (obtained from machine learning engine 302) that satisfies the input/output access requirements for the designated level of urgency (e.g., critical), which was obtained from the data structure discussed above. Furthermore, such a path (path 106B) may be tagged to a CPU core 202 (e.g., CPU core 202B) with a core speed (obtained from core speed identifier module 305 in operation 606) that satisfies the required range of CPU core speeds for the designated level of urgency (e.g., critical), which was obtained from the data structure discussed above. As a result, in such an example, path 106B would be selected by path selection logic 306 to be used to send a request (e.g., read request) from non-relational database system 102 to storage system 103 (e.g., disk volume 105A) in which the urgency of the query is propagated to storage system 103 along such a selected path 106.

In one embodiment, in the scenario in which a path 106 is not identified that satisfies the input/output access requirements for the designated level of urgency (e.g., critical), path selection logic 306 selects the path that most closely satisfies the input/output access requirements for the designated level of urgency and is tagged to a CPU core 202 that satisfies or most closely satisfies the required range of CPU core speeds for the designated level of urgency (e.g., critical).

In operation 608, non-relational database system 102 sends the request (e.g., read request) to storage system 103 over the selected logical or physical input/output connection 106. That is, non-relational database system 102 sends the request over the selected logical or physical input/output connection 106 that is connected to the appropriate disk volume 105 (disk volume 105 identified from a record of the requested object).

In this manner, embodiments of the present disclosure provide a means for a non-relational database (e.g., NoSQL database) to utilize the multiple input/output connections created in a multi-connection input/output transmission protocol (e.g., NVMe) in which the query urgency is propagated to the storage system along one of these input/output connections.

Furthermore, the principles of the present disclosure improve the technology or technical field involving non-relational databases. As discussed above, a transmission protocol, such as NVMe® (non-volatile memory express), may be utilized for accessing non-volatile storage media, such as the non-volatile storage media in the storage system connected to a non-relational database, such as a NoSQL database. Using such technology may result in many input/output connections being created over a single physical connection to gain the benefits of parallelizing input/output connections. As a result, a NoSQL disk volume may have multiple paths (“multipath”), each path having one or more input/output queues which are tagged to a dissimilar CPU core in the storage system. In such a scenario, there could be clock speed differences between the CPU cores which can affect the input/output performance when requested on certain paths. Unfortunately, NVMe based standards have no multipath policy. As a result, the NoSQL database cannot obtain information about the multiple input/output connections created for the same disk volumes. Furthermore, if an application, such as AI application, issues a query desiring to retrieve an object (e.g., JSON object) urgently (requiring immediate retrieval) from the storage system, there is not currently a means for propagating such a query urgency (e.g., retrieval urgency) to the storage system, such as over one of these input/output connections, due to the operational differences between the NoSQL database and the storage system. Hence, there is not currently a means for NoSQL databases to utilize the multiple input/output connections created in a multi-connection input/output transmission protocol (e.g., NVMe) as well as propagate a query urgency to the storage system, such as via one of these input/output connections.

Embodiments of the present disclosure improve such technology by receiving a query to retrieve an object from a storage system of a non-relational database system (e.g., NoSQL database system) from an application, such as an AI application, where the storage system is connected to the non-relational database system via a hybrid cloud environment. In one embodiment, the storage system is an object based storage system, in which data is stored in the form of “objects” in the storage system on flat address space based on its content and other attributes. A disk volume of the storage system is then identified from a record of the requested object, such as an identifier (e.g., label) that is associated with such a disk volume. Upon identifying the disk volume, the logical and/or physical input/output connections to the identified disk volume that are tagged to dissimilar CPU cores are identified, such as via a data structure storing a listing of the logical and/or physical input/output connections connected to various disk volumes of the storage system. In one embodiment, each of the logical and/or physical input/output connections include one or more input/output queues tagged to a central processing unit (CPU) core of the storage system. After the CPU core speeds (e.g., clock speeds) for the CPU cores of the storage system are obtained, one of the identified logical and/or physical input/output connections connected to the identified disk volume is selected based on the input/output access characteristics of the identified logical and/or physical input/output connections, the CPU core speeds for the CPU cores and a determined level of urgency for the retrieval of the object. In one embodiment, such input/output access characteristics (e.g., input/output latency, bandwidth, response time, packet drops, congestion, etc.) and CPU core speeds for the CPU cores are obtained from data structures (e.g., tables). In one embodiment, the level of urgency for the retrieval of the object is determined based on the object category of the object requested to be retrieved and/or the type of application requesting to retrieve the object. Based on the determined level of urgency (e.g., critical) for the retrieval of the object, the required input/output access characteristics for the input/output connection as well as the required CPU core speed to be utilized in sending the request to the storage system to retrieve the object is determined, such as via a data structure listing such requirements associated with various levels of urgency. After identifying one of the input/output connections from the identified input/output connections that is tagged to a CPU core that both meet or most closely meets such requirements, the non-relational database system sends the request (e.g., read request) to the storage system over the selected input/output connection in a hybrid cloud environment. In this manner, the non-relational database system is able to utilize multiple input/output connections established by a multi-connection input/output transmission protocol (e.g., NVMe) in which the urgency of the query is propagated to the storage system along one of these input/output connections. Furthermore, in this manner, there is an improvement in the technical field involving non-relational databases.

The technical solution provided by the present disclosure cannot be performed in the human mind or by a human using a pen and paper. That is, the technical solution provided by the present disclosure could not be accomplished in the human mind or by a human using a pen and paper in any reasonable amount of time and with any reasonable expectation of accuracy without the use of a computer.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method for managing queries to non-relational databases, the method comprising:
receiving a query to retrieve an object from a storage system of a non-relational database system;
identifying a disk volume of said storage system from a record of said object;
identifying logical and/or physical input/output connections to said disk volume of said storage system, wherein each of said logical and/or physical input/output connections corresponds to a path from said non-relational database to said disk volume of said storage system, wherein each of said logical and/or physical input/output connections comprises one or more input/output queues tagged to a dissimilar central processing unit (CPU) core of said storage system;
obtaining CPU core speeds for CPU cores of said storage system;
selecting one of said identified logical and/or physical input/output connections to be used to send a request to said storage system to retrieve said object based on input/output access characteristics of said identified logical and/or physical input/output connections, said CPU core speeds for said CPU cores and a determined level of urgency for retrieval of said object; and
sending said request to said storage system over said selected logical or physical input/output connection.

2. The method as recited in claim 1 further comprising:
collecting input/output statistics for each of a plurality of paths from said non-relational database to said stage system to assess an input/output workload and latency of respective paths.

3. The method as recited in claim 2 further comprising:
building a pattern of input/output access characteristics over each of said plurality of paths using said collected input/output statistics.

4. The method as recited in claim 2, wherein said plurality of paths occur over a hybrid network environment connected between said non-relational database system and said storage system.

5. The method as recited in claim 1 further comprising:
obtaining urgency information pertaining to said query; and
determining said level of urgency for retrieval of said object based on said obtained urgency information.

6. The method as recited in claim 5, wherein said obtained urgency information is selected from the group consisting of an object category of said object requested to be retrieved and a type of application requesting to retrieve said object.

7. The method as recited in claim 1, wherein said query to retrieve said object is received from an artificial intelligence application.

8. A computer program product for managing queries to non-relational databases, the computer program product comprising one or more computer readable storage mediums having program code embodied therewith, the program code comprising programming instructions for:
receiving a query to retrieve an object from a storage system of a non-relational database system;
identifying a disk volume of said storage system from a record of said object;
identifying logical and/or physical input/output connections to said disk volume of said storage system, wherein each of said logical and/or physical input/output connections corresponds to a path from said non-relational database to said disk volume of said storage system, wherein each of said logical and/or physical input/output connections comprises one or more input/output queues tagged to a dissimilar central processing unit (CPU) core of said storage system;
obtaining CPU core speeds for CPU cores of said storage system;
selecting one of said identified logical and/or physical input/output connections to be used to send a request to said storage system to retrieve said object based on input/output access characteristics of said identified logical and/or physical input/output connections, said CPU core speeds for said CPU cores and a determined level of urgency for retrieval of said object; and
sending said request to said storage system over said selected logical or physical input/output connection.

9. The computer program product as recited in claim 8, wherein the program code further comprises the programming instructions for:
collecting input/output statistics for each of a plurality of paths from said non-relational database to said stage system to assess an input/output workload and latency of respective paths.

10. The computer program product as recited in claim 9, wherein the program code further comprises the programming instructions for:
building a pattern of input/output access characteristics over each of said plurality of paths using said collected input/output statistics.

11. The computer program product as recited in claim 9, wherein said plurality of paths occur over a hybrid network environment connected between said non-relational database system and said storage system.

12. The computer program product as recited in claim 8, wherein the program code further comprises the programming instructions for:
obtaining urgency information pertaining to said query; and
determining said level of urgency for retrieval of said object based on said obtained urgency information.

13. The computer program product as recited in claim 12, wherein said obtained urgency information is selected from the group consisting of an object category of said object requested to be retrieved and a type of application requesting to retrieve said object.

14. The computer program product as recited in claim 8, wherein said query to retrieve said object is received from an artificial intelligence application.

15. A system, comprising:
a memory for storing a computer program for managing queries to non-relational databases; and
a processor connected to said memory, wherein said processor is configured to execute program instructions of the computer program comprising:
receiving a query to retrieve an object from a storage system of a non-relational database system;
identifying a disk volume of said storage system from a record of said object;
identifying logical and/or physical input/output connections to said disk volume of said storage system, wherein each of said logical and/or physical input/output connections corresponds to a path from said non-relational database to said disk volume of said storage system, wherein each of said logical and/or physical input/output connections comprises one or more input/output queues tagged to a dissimilar central processing unit (CPU) core of said storage system;
obtaining CPU core speeds for CPU cores of said storage system;
selecting one of said identified logical and/or physical input/output connections to be used to send a request to said storage system to retrieve said object based on input/output access characteristics of said identified logical and/or physical input/output connections, said CPU core speeds for said CPU cores and a determined level of urgency for retrieval of said object; and
sending said request to said storage system over said selected logical or physical input/output connection.

16. The system as recited in claim 15, wherein the program instructions of the computer program further comprise:
collecting input/output statistics for each of a plurality of paths from said non-relational database to said stage system to assess an input/output workload and latency of respective paths.

17. The system as recited in claim 16, wherein the program instructions of the computer program further comprise:
building a pattern of input/output access characteristics over each of said plurality of paths using said collected input/output statistics.

18. The system as recited in claim 16, wherein said plurality of paths occur over a hybrid network environment connected between said non-relational database system and said storage system.

19. The system as recited in claim 15, wherein the program instructions of the computer program further comprise:
obtaining urgency information pertaining to said query; and
determining said level of urgency for retrieval of said object based on said obtained urgency information.

20. The system as recited in claim 19, wherein said obtained urgency information is selected from the group consisting of an object category of said object requested to be retrieved and a type of application requesting to retrieve said object.
